(19) United States
(12) Patent Application Publication
(10) Pub. No.: US 2016/0221243 A1
(43) Pub. Date: Aug. 4, 2016

(54) UNIT FOR FEEDING PASTY PRODUCTS ONTO A BELT

(71) Applicant: ANDRITZ Technology and Asset Management GmbH, Graz (AT)

(72) Inventors: Heinz Baldauf, Stiefenhofen (DE); Paul Kroehl, Ravensburg (DE)

(21) Appl. No.: 15/007,377

(22) Filed: Jan. 27, 2016

(30) Foreign Application Priority Data
Jan. 30, 2015 (AT) A 50073/2015

(51) Int. Cl. B29C 47/10; B29C 47/34; B29C 47/08

(52) U.S. Cl. CPC B29C 47/10; B29C 47/0838; B29C 47/34

(57) ABSTRACT

A device for feeding pasty products onto a belt, including a die in the form of a shaft located in a housing. The shaft has diametrically opposed, longitudinally extending grooves or recesses, with channels passing radially through the shaft between the grooves. Pressurized feed material fills one groove and extrudes through the channels to exit uniformly into the other groove for deposition on the belt. The flow direction through the channels can be reversed by rotating the shaft, and the channels are thus cleaned.

### BACKGROUND

The invention relates to a feed unit for extruding and feeding pasty products onto a belt, and plant including such a feed unit.

In convective drying of pasty products, it is essential to use granulation to create enough surface area for the mass and heat transfer. In most convective dryers, such as fluidized bed equipment, drum dryers, and flash tube dryers, this alone is adequate. In belt dryers, an additional requirement must be met. On these belts, the granulated product rests on a conveyor belt that is permeable to gas and on which it is conveyed straight through a current of hot gas. In order to ensure efficient, even drying, the product must not only be granulated, but also applied evenly with a constant layer thickness to the belt with gas flowing through it so that a homogeneous, porous layer is obtained through which the drying gas can flow evenly.

These requirements are met in different ways. A common method is to granulate the materials by means of agglomeration in a mixer or granulating device. In this process, the pasty product is blended with the recycled dry product in the correct proportions and attains a crumbly structure when mechanical energy is applied. At the belt dryer, the free-flowing granulate is applied to the belt by screw conveyors, scrapers, and similar, maintaining a constant layer height. The disadvantage of this process is the increased amount of equipment and control instrumentation required. Additional conveying elements, granulating equipment and distribution devices are needed, and precise dosing of moist and dry product must be ensured because there is only a narrow moisture content range for mixing in which granulation provides satisfactory results.

Alternative processes break down the moist, pasty product by means of rotating tools such as milling cutter-like rolls, impellers and pin wheels, cage wheels, rotary chopper wheels, or similar devices. However, these have failed to establish themselves in belt dryers.

A third important process is the extrusion of pasty products through a die with several holes that divide the product into thinner strands. The product must be suitable for pumping so that it can flow through the holes in the die. For this purpose, pressure must be built up ahead of the die, and this can be achieved in many different ways. Upstream displacement pumps, such as piston pumps, helical rotor pumps, twin-shaft screw conveyors, etc., lend themselves to such tasks and allow the conveying and shaping sections to be separated in terms of space. In addition, integrated devices have established their presence, such as edge mills, where a roll pair runs on the perforated die and the pressure is built up in the roll gap. What these processes have in common is that the spatial expansion of the die is only a few decimeters.

Hence, the die must run over the considerably larger belt width (up to several meters) in order to achieve even feeding if it is to be used in a belt dryer.

DE 3518323 A1 describes a device that avoids this disadvantage by giving the die an oblong shape extending over the entire width of the belt in the base of a box. The pressure is generated by a flap valve that pivots back and forth in the box, covers one half of the die and has a rotational axis that is centered in the longitudinal direction of the die. The material is fed in through a feed unit mounted up above, also extending over the entire length. One variant of this principle is found in the so-called pivoting press manufactured by EL-A Verfahrenstechnik GmbH, where the flap valve is replaced by a cylinder with two longitudinal sealing strips. The cylinder oscillates in a trough with a semi-circular, dished base, which also has a sealing strip at its lowest point. The perforated die runs to the left and right of this strip in a narrow sector, but over the entire length. Due to the oscillating movement, the areas formed by the three strips are filled alternately with pasty product and emptied again through the holes in the die.

What all die processes have in common, however, is the blinding tendency of the holes measuring only a few millimeters, caused by foreign objects, particularly fibers, such as hair, which occurs in larger quantities in sewage sludge in particular. DE 3518323 A1 describes how a suction effect that displaces the fibers slightly and should push them out during the next pressing cycle is to be created by special adjustment of the rotation angle speed of the press flap valve. However, hair especially tends to become trapped over two holes because of its considerable length compared to the dimensions of the hole and this cannot be prevented by only slight displacement. U.S. Pat. No. 2,487,910 shows an extruding device intended for production of plastic parts in strand form. As only pure products are used here, blinding is not an issue. DE 10 2013 025 259 also shows a device for continuous casting of thermoplastics.

U.S. Pat. No. 5,921,001 shows a plant for drying or cooling a product that is fed onto a belt by means of an oscillating chute.

### SUMMARY

The object of the invention is to create a feed unit device for the die process in which the blinding tendency is eliminated.

The invention is thus characterized in that the shaft has grooves into which the feed and outflow holes of the channels discharge. Due to the die having the form of a shaft, the flow direction can be reversed by rotating it, resulting in the channels being cleaned and the contaminants removed more easily from the grooves.

An advantageous further development of the invention is characterized in that the shaft has at least one or preferably two rows of channels, where each row of channels comprises between four and ten, for example six, channels. As a result, the shaft can be adapted particularly well to the desired throughput.

A favorable embodiment is characterized in that the diameter of the channels is between 2 and 30 mm, preferably between 5 and 10 mm. As a result, the shaft can be adapted particularly well to the characteristics of the product.

A favorable further development is characterized in that the shaft is provided with a drive that makes it possible to rotate the shaft in order to reverse the direction of flow. In this way, a cleaning cycle can be implemented automatically, where the flow direction can be reversed as well in the event of a sudden blockage, enabling a cleaning cycle to be initiated immediately.

The invention also relates to a plant that is characterized in that a feed screw is provided immediately above the feed unit and a continuously revolving belt is provided immediately below the feed unit. In this way, the necessary pressing force for extruding the material can be applied continuously by the screw conveyor to the inlet groove of the feed unit and the extruded material carried off continuously by the belt. The belt can be made preferably of textile or metal mesh, perforated segments, or trays arranged next to one another and with a base that is permeable to gas.

A favorable embodiment is characterized in that the belt is the drying belt of a belt dryer. The feed unit according to the present disclosure can be used advantageously, especially in belt dryers, in order to distribute the product to be dried as evenly as possible.

An advantageous embodiment is characterized in that the feed unit has a pivoting arrangement, or where the feed unit can be moved in a linear direction as an alternative.

A favorable further development is characterized in that the feed unit is mounted at right angles to the conveying direction of the belt and extends over the entire belt width as well as over one or several rows of the channels in the die. The number of channels in each row is selected such as to provide even distribution of the extruded material over the width of the belt.

The reduced blinding tendency is largely achieved by reversing the flow direction in the die regularly without interrupting the dosing process so that any blinding of individual holes or channels beginning on the discharge side can be discharged easily in the direction of the belt when the flow direction has been reversed. This guarantees continuous operation without interruption and consistent product distribution quality without regular or unexpected interruptions for cleaning.

### BRIEF DESCRIPTION OF THE DRAWING

Embodiments of the invention will now be described in examples, with reference to the drawing, where

FIG. 1 shows a longitudinal section through a feed unit according to an aspect of the invention;

FIG. 2 shows a cross-section through line II-II of FIG. 1;

FIG. 3 shows a view of a plant according to another embodiment of the invention; and

FIG. 4 shows a top view of the plant according to FIG. 3.

### DETAILED DESCRIPTION

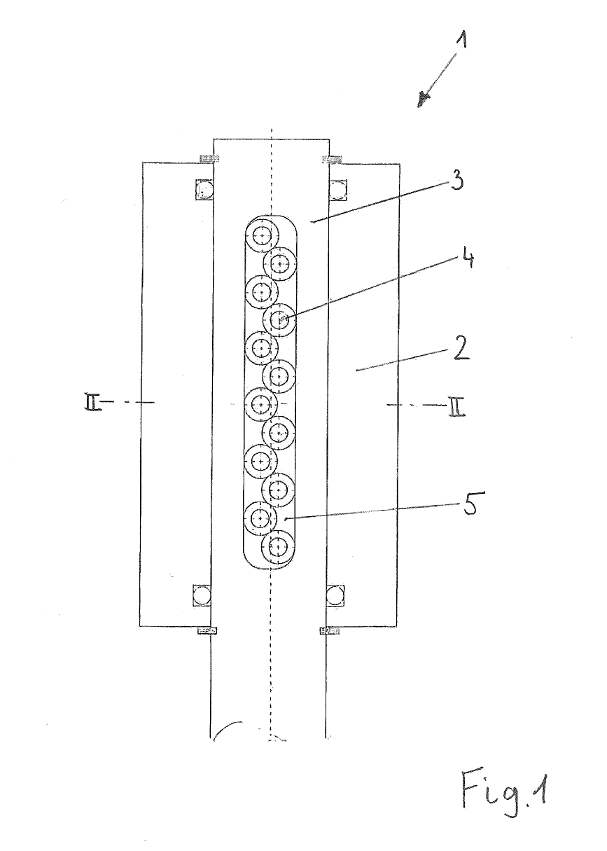

FIG. 1 shows a longitudinal section of a feed unit 1 according to an embodiment of the invention. This has a housing 2 in which a shaft 3 is arranged within closely conforming housing sidewalls. The shaft serves as a die, made with one or several radial rows of channels, designed here as two rows of cylindrical bore holes 4, with conical lead-ins. Each row contains six channels in this example, whereas four to ten channels would be in the typical range. However there can also be significantly more or fewer channels depending on the dosage capacity. The hydraulic diameter of the channels depends on the rheological properties of the pasty product and lies between 2 and 30 mm, typically between 5 and 10 mm.

The shaft 3 is levelled off or dished longitudinally at the circumference, e.g., with a groove 5, above the row of channels 4. This groove at the upper side of the shaft forms a basin with channel openings in the bottom, and acts as a manifold for facilitating the uniform pressing pressure of the material entering all the channels. This groove also makes drilling the channels easier. Another longitudinal groove is provided on the diametrically opposite side of the shaft, which helps to carry along foreign objects during the rotation described below. The required pressing force can be influenced by the length and shape of the channels.

The shaft 3 runs typically in the housing 2 through which the pasty product, e.g. sewage sludge, is fed in. The die shaft 3 is rotated at periodic intervals, depending on the blinding tendency, so that the flow direction in the channels 4 reverses and any foreign objects in front of the former inlet channels are pressed out. In this way, fibers and hair with the ends stuck in two different channels are also removed.

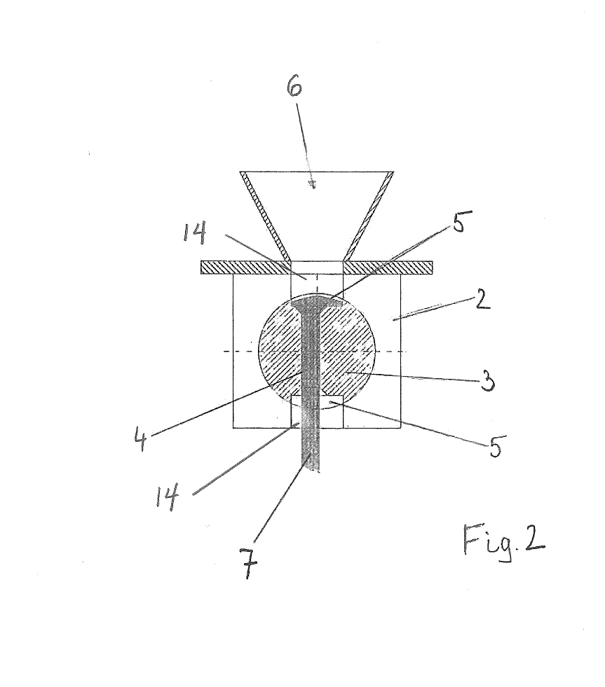

FIG. 2 shows a cross-section through the feed unit along the line marked II-II in FIG. 1. The pasty product is pressed from above through a feed guide 6 into an opening 14 at the top of the housing 2 and into the groove 5 by a suitable conveying device and leaves it again through the shaping channels 4 and opening 14 as multiple strands 7, which land on the belt and then enter the dryer. The pasty product is pressed against the entire bottom surface of the groove, through each conical entry of the channels, and out the conical exit of the channels into the opposite groove, before passing out of the feed unit.

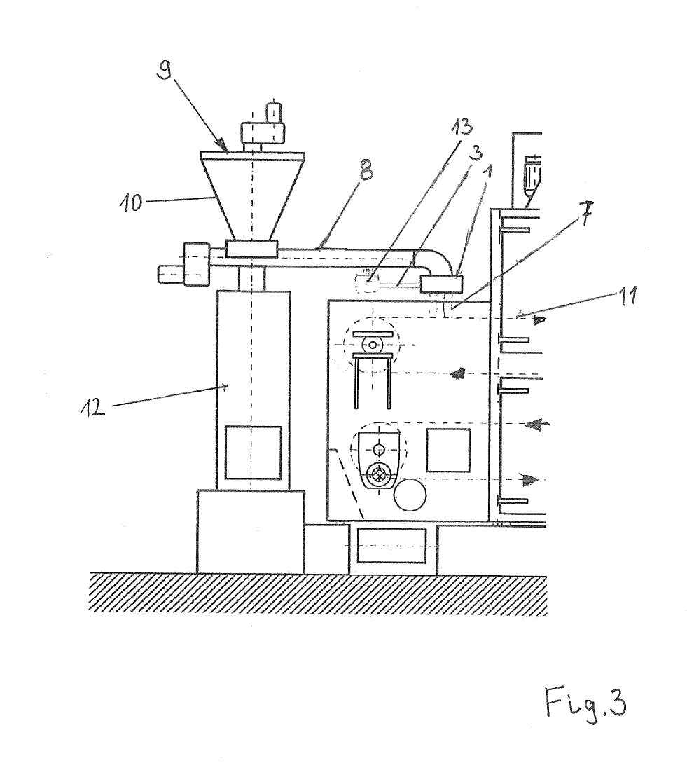

FIG. 3 shows a plant with a feed unit 1 of the type shown in FIGS. 1 and 2, in combination with a two-stage belt dryer. The feed unit 1 is mounted at the outlet of screw pump 8. The pasty product 9 is fed to the screw pump 8 via a storage tank 10, extruded through the feed unit 1 and discharged as strands 7 onto the drying belt 11 of the first stage. The feed unit 1 is supported here on a pivoting drive 12 together with the screw pump 8. The entire width of the belt 11 is covered evenly due to the controlled pivoting movement. In order to achieve this, the pivoting speed must be aligned with the belt speed, the output, and the selected geometry of the shaft. As an alternative, the feed unit can also be mounted in a linear arrangement such that it can be moved at right angles to the belt running direction.

The shaft 3 of the feed unit 1 is provided with a drive 13. In the housing 2 of the device 1, the die shaft 3 is rotated by the drive 13 when necessary until the conveying direction through the channels 4 is reversed.

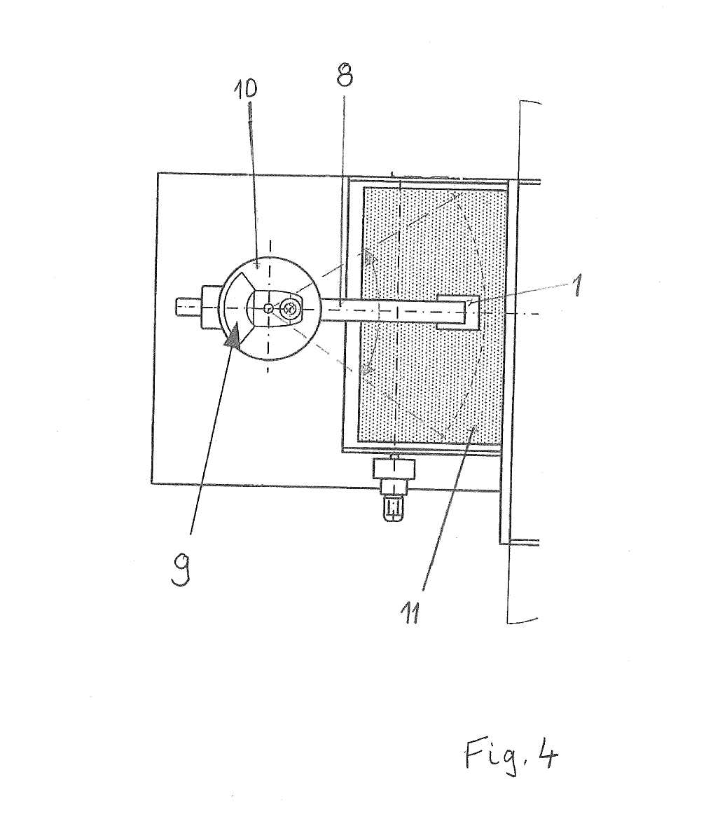

FIG. 4 shows a top view of the plant according to FIG. 3, where the pivoting angle of the screw pump 8 with feed unit 1 and the area in which the product strand 7 is deposited can be identified easily.

The invention is not limited to the examples shown. In fact, the discharge unit can be designed such that it is movable if necessary or extends over the entire belt width.

1. A feed unit for pasty material, comprising:
a housing with a feed opening;
a shaft passing longitudinally through the housing below the feed opening;
one groove with a bottom extending longitudinally along one side of the shaft;
and another groove with a bottom extending longitudinally along a diametrically opposed other side of the shaft; and
a plurality of channels each having an opening at the bottom of said one groove and passing radially through the shaft to an opening at the bottom of said other groove.

2. The feed unit according to claim 1, wherein the shaft has at least one row of channels.

3. The feed unit according to claim 1, wherein the channels have a diameter of between 2 and 30 mm.

4. The feed unit according to claim 1, wherein
pasty material passing into the feed unit through the feed opening in the housing enters said one groove, extrudes in a downward flow direction through the channels, and is discharged at the other side of the shaft through said other groove; and
a drive is provided for selectively rotating the shaft in order to reverse the grooves and channels and then extrude material in said downward direction of flow through the channels.

5. The feed unit according to claim 1, wherein two rows of channels are provided, each row having between four and ten channels.

6. The feed unit according to claim 1, wherein
the shaft has at least two rows of channels;
the shaft is selectively alignable with said one groove under the feed opening of the housing;
a pressing device is provided at the feed opening of the housing, for delivering pasty material under pressure along the entire bottom of said one groove and into the channel openings in said one groove.

7. The feed unit according to claim 6, wherein each channel opening is conical.

8. The feed unit according to claim 6, wherein each channel has a diameter between 5 and 10 mm.

9. The feed unit according to claim 7, wherein each channel has a main diameter between 5 and 10 mm.

10. A plant with a feed unit according to claim 1, including a pressurized feed screw with an outlet that conveys pasty material to the feed opening of the housing.

11. The plant according to claim 10, including a continuously revolving belt situated below the other groove of the feed unit.

12. The plant according to claim 11, wherein the belt is the drying belt of a belt dryer.

13. The plant according to claim 11, wherein
the belt has a width and travels in a linear conveying direction; and
the feed unit is supported over the belt with a drive that pivots the feed unit in a reciprocal motion through an angle that spans the width of the belt.

14. The plant according to claim 11, wherein
the belt has a width and travels in a linear conveying direction; and
the feed unit is supported over the belt with a drive that moves the feed unit perpendicularly along the width of the belt.

15. The plant according to claim 11, wherein
the belt has a width and travels in a linear conveying direction; and
the grooves of the feed unit extend perpendicularly to the belt conveying direction across the entire belt width.
